(19) United States
(12) Patent Application Publication
(10) Pub. No.: US 2021/0102832 A1
(43) Pub. Date: Apr. 8, 2021

(54) METHOD FOR DETECTING A MEASURING ERROR DURING A MEASUREMENT OF A MEDIA PROPERTY OF A MEDIUM BY MEANS OF A FIELD DEVICE IN MEASUREMENT AND AUTOMATION TECHNOLOGY, AND AN ULSTRASONIC FLOW RATE MEASURING DEVICE OR ULTRASONIC FILL LEVEL MEASURING DEVICE FOR CARRYING OUT SAID METHOD

(71) Applicant: Endress+Hauser Flowtec AG, Reinach (CH)

(72) Inventors: Achim Wiest, Weil am Rhein (CH); Oliver Brumberg, Rheinfelden (CH)

(21) Appl. No.: 16/956,430

(22) PCT Filed: Dec. 10, 2018
(86) PCT No.: PCT/EP2018/084176

§ 371 Date: Jun. 19, 2020

(30) Foreign Application Priority Data
Dec. 21, 2017 (DE) 10 2017 130 097.5

(51) Int. Cl. G01F 25/00; G01F 23/296; G01F 1/66

(52) U.S. Cl. CPC G01F 25/0007; G01F 1/667; G01F 23/296; G01F 25/0061

(57) ABSTRACT

A method of the disclosure relates to detecting a measuring error during a measurement of a media property of a medium using a field device, wherein in a first step a measurement of a first media property is taken using the field device, wherein an electronic measuring/operating circuit provides a measured value of the first media property, wherein in a second step a second media property is measured using a sensor provided therefor, wherein the electronic measuring/operating circuit provides a sensor measured value, wherein in a third step a known relationship between the first media property and the second media property is used to calculate a second media property from the first media property, wherein in a fourth method step a statement about the functional capability of the corresponding sensor or measuring device is derived by comparing the sensor measured value with a calculation value.

The invention relates to a method for detecting a measuring error during a measurement of a media property of a medium located in a container by means of a field device in measurement and automation technology, and an ultrasonic flow meter or ultrasonic fill level measuring device used for carrying out said method.

In the technical field of measuring and automation technology, various field devices are used, by means of which at least one property of a medium can be measured. Frequently, at least one further sensor for measuring one or more other medium properties is assigned to the field device.

For example, document DE 100 57 188 A1 shows an ultrasonic flow meter comprising a temperature sensor for temperature compensation since, for example, an ultrasonic signal propagation time is dependent on the temperature of a medium flowing through a measuring tube.

However, technical devices are, in principle, prone to errors and can fail, such a failure being able to occur gradually over an extended period of time, which makes the detection of the failure significantly more difficult.

The object of the invention is therefore to propose a method and an ultrasonic flow or an ultrasonic fill level measuring device, so that a failure of a field device or of an assigned sensor can be detected.

The object is achieved by a method according to independent claim 1, and by devices according to independent claim 11.

In a method according to the invention for detecting a measuring error during a measurement of a media property of a medium located in a container by means of a field device in measurement and automation technology, at least one measurement of at least one first media property is taken by means of the field device, wherein an electronic measuring/operating circuit provides at least one measured value of the first media property,

wherein at least one second media property different from the at least one first media property is measured in each case directly by means of at least one sensor provided therefor, wherein the electronic measuring/operating circuit provides at least one sensor measured value based on a measurement signal generated by the sensor;
wherein
a known relationship between the first media property and the second media property is used to calculate the second media property from the at least one first media property by means of the electronic measuring/operating circuit, wherein the electronic measuring/operating circuit in each case provides at least one calculation value;
wherein a statement about the functional capability of the corresponding sensor or of the field device is derived by comparing the sensor measured value with the calculation value.

By taking advantage of the known relationship between at least one first media property and at least one second media property, it is thus possible to check, by means of measured medium properties and by means of the relationship of calculated medium properties, whether the field device or the assigned sensor is functioning, in the event that functioning is ensured in the assigned sensor or in the field device. A minimum deviation between measured medium properties and calculated medium properties may be interpreted as an indication of a malfunction or of a failure.

In one embodiment of the method, in the case of at least two different sensor measured values, at least one calculation value is used in each case for detecting a measuring error of the first media property or of the second media property.

This can be advantageous in the case of a non-linear relationship between the at least one first media property and the at least one second media property. For example, if the relationship is not monotonic, there may be exactly one value of a first media property in the case of different values of a second media property. Adding a measured value of a second media property provides valuable additional information, by means of which the described ambiguity can be eliminated. A plurality of first measured values can be determined for each second measured value in order to thereby reduce an uncertainty of a measurement of the corresponding first media property. The same also applies to the second media property.

In one embodiment of the method, different sensors are used for measurements of n different second medium properties, wherein the electronic measuring/operating circuit provides a group of sensor measured values,

wherein each element of the group is assigned sensor measured values of each media property to be measured,
wherein in each case at least one calculation value for at least two and, especially, at least n different elements is used for detecting a measuring error of a media property, wherein n is a natural number greater than 1.

If the known relationship encompasses at least n second medium properties and is thus multidimensional, it may be advantageous to use a plurality of measured values, especially of different second medium properties.

In one embodiment of the method, the first media property and the second media property are at least one of the following list: temperature, pressure, density, viscosity, electrical conductivity, thermal conductivity, compressibility, adiabatic coefficient, pH value.

In one embodiment of the method, the field device is a magnetically inductive flow meter and measures the electrical conductivity of the medium,

or wherein the field device is a Coriolis measuring device, especially, a Coriolis flow meter, and measures the density and, especially, the viscosity of the medium,
or wherein the field device is an ultrasonic flow meter or an ultrasonic fill level measuring device and measures the speed at which sound travels in the medium,
or wherein the field device is a thermal flow meter and measures a temperature or thermal conductivity of the medium.

In one embodiment of the method, the ultrasonic flow meter operates according to the propagation time difference principle, and wherein the container is a measuring tube through which the medium flows.

In one embodiment of the method, the medium is gaseous or liquid,

wherein the medium includes at least one of the following substances:
water, one or more hydrocarbon compounds, air.

In one embodiment of the method, a notification is output when a calculation value deviates from an associated sensor measured value by more than 20% and, especially, by more than 10% and preferably by more than 2%.

In one embodiment of the method, the sensor belonging to the sensor measured value is recalibrated based on the measured deviation.

In one embodiment of the method, the electronic measuring/operating circuit tracks the progression of a deviation between the sensor measured values and the associated calculation values and, especially, records them.

An ultrasonic flow meter or ultrasonic filling level measuring device according to the invention, used for implementing a method according to any of the preceding claims, comprises:

at least one first ultrasonic transducer for generating and detecting an ultrasonic signal;
at least one sensor for detecting a media property and/or at least one terminal for connecting a sensor for detecting a media property;
an electronic measuring/operating circuit for operating the field device.

In one embodiment, the ultrasonic fill level measuring device is attached to a container,

wherein the container is, especially, a tank.

In one embodiment, the ultrasonic flow meter comprises a container,

wherein the container is a measuring tube, which is designed to conduct the medium.

In one embodiment, the ultrasonic flow meter comprises a second ultrasonic transducer for measuring the speed at which sound travels in the medium.

The invention will now be described with reference to exemplary embodiments.

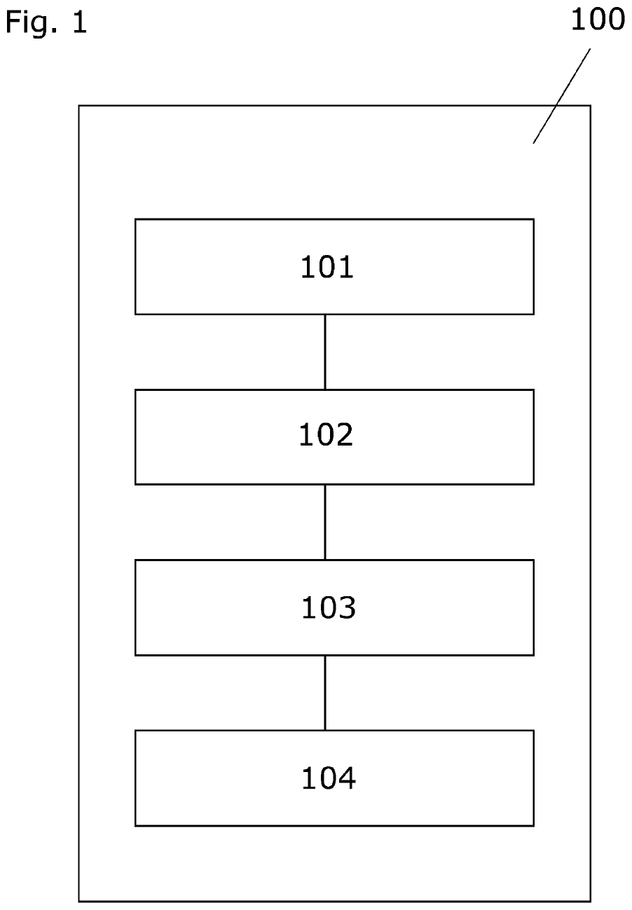

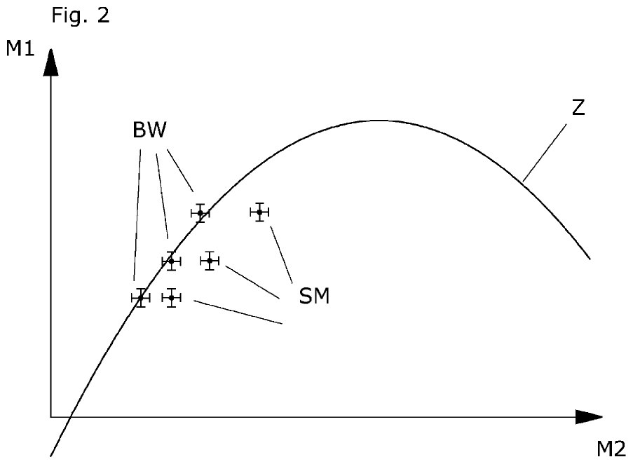

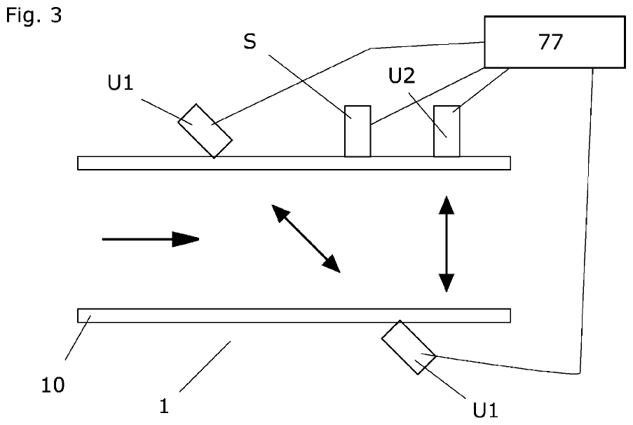

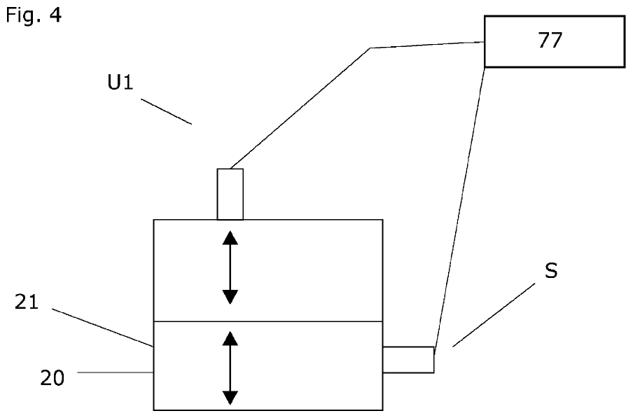

FIG. 1 outlines the flow of a method according to the invention; and FIG. 2 shows an exemplary relationship between a first media property and a second media property, by means of which relationship the sensor measured values are verified by calculation values, or the calculation values are verified by sensor measured values; and FIG. 3 shows an ultrasonic flow meter; and FIG. 4 shows an ultrasonic fill level measuring device.

FIG. 1 outlines the flow of method steps of a method 100 according to the invention for detecting a measuring error during a measurement of a media property of a medium located in a container by means of a field device in measurement and automation technology,

wherein, in a first method step 101, at least one measurement of at least one first media property M1 is taken by means of the field device, an electronic measuring/operating circuit providing at least one measured value MF of the first media property, wherein, in a second method step 102, at least one second media property M2, which differs from the at least one first media property, is measured in each case directly by means of a sensor provided therefor, the electronic measuring/operating circuit providing at least one sensor measured value SM based on a measurement signal generated by the sensor, wherein, in a third method step 103, a known relationship between at least one first media property and the at least one second media property is used to calculate the at least one second media property from the at least one first media property by means of the electronic measuring/operating circuit, the electronic measuring/operating circuit in each case providing at least one calculation value BW, wherein, in a fourth method step 104, a statement about the functional capability of the corresponding sensor or of the measuring device is derived by comparing the at least one sensor measured value SM with the at least one calculation value.

The relationship between the at least one first media property and the at least one second media property can be, for example, a relationship between the temperature of the medium and the speed of sound. For example, the temperature may not just be considered as being dependent on the speed of sound, but also, for example, on the density and/or the viscosity of the medium. This can be relevant, for example, in an ultrasonic flow meter or in an ultrasonic fill level measuring device comprising an additional temperature sensor.

Thus, by providing at least one calculation value BW of at least one second media property and comparing it with the corresponding sensor measured values SM of the second media property, either the measurement of the field device or the measurement of the sensor can be verified, depending on whether the field device or the sensor is recognized as being reliable. In a relationship between a first media property and a second media property, the calculation of a single calculation value may be sufficient for a verification of the field device or of the sensor. However, by means of at least one repetition of the measurement of the first media property and calculation of corresponding calculation values, a measuring accuracy can be increased, and thus the meaningfulness of a statement with respect to the reliability of the field device or of the sensor can be increased. If a lack of reliability is detected by the electronic measuring/operating circuit 77, for example, a warning can be output. As a result, a repair or a replacement of the field device or of the sensor can be prompted. When a plurality of calculation values BW are created based on different measured values of a first media property which belong to a measurement variable, the statement with respect the reliability of the field device or of the sensor can also encompass information about the form of a deviation of the field device or sensor from a target state. Having knowledge of the deviation allows, for example, for the deviation to be compensated for, which ensures that the field device or the sensor is operational until replaced or repaired. The same also applies in the case of more complex, multi-dimensional relationships between at least one first media property and at least one second media property.

FIG. 2 outlines an exemplary relationship between a first media property M1 and a second media property M2, by means of which the sensor measured values can be verified by calculation values, or calculation values can be verified by sensor measured values.

FIG. 2 shows a situation in which calculation values BW having uncertainties with respect to the first media property and the second media property correspond to a relationship Z between the first media property M1 and a second media property M2, wherein sensor measured values SM having uncertainties with respect to the first media property and the second media property do not agree with the associated calculation values. The uncertainties are represented by range markings, and the calculation values or sensor measured values are represented by dots. If a plurality of calculation values and a plurality of sensor measured values are known, it can be estimated whether there is a lack of agreement, for example, due to a constant offset of the sensor measured values with respect to the media property M2, or whether the offset is dependent on the media property M1 as shown in FIG. 2. In the first case, for example, a simple compensation of the offset could be carried out. When checking the agreement, it is also possible to take only an uncertainty of the calculation values or of the sensor measured values with respect to the first media property or the second media property into account. The same applies to the case in which measured values of the field device are verified via the calculation values by means of the sensor measured values. The same applies accordingly for more complex relationships in which the at least one first media property depends on a plurality of second medium properties.

FIG. 3 shows a schematic ultrasonic flow meter 1 comprising a measuring tube 10 and two first ultrasonic transducers U1 and an electronic measuring/operating circuit 77, wherein the flow meter can be designed as a clamp-on ultrasonic flow meter or as an in-line ultrasonic flow meter and preferably operates according to the propagation time difference principle. The flow meter 1 furthermore comprises a sensor S and, as illustrated in FIG. 3, can comprise a second ultrasonic transducer, wherein the sensor is designed to measure a second media property. The electronic measuring/operating circuit is designed to determine a first media property by means of the first ultrasonic transducers U1 and/or by means of the second ultrasonic transducer U2, and to carry out the method according to the invention.

FIG. 4 shows a schematic ultrasonic fill level measuring device (2) comprising a first ultrasonic transducer for determining a fill level height of a medium located in a container 20 or, especially, in a tank 21, wherein the ultrasonic flow meter comprises a sensor (S) for determining a second media property and an electronic measuring/operating circuit 77, which is designed to operate the first ultrasonic transducer and the sensor. The electronic measuring/operating circuit is designed to determine a first media property by means of the first ultrasonic transducers U1 and to carry out the method according to the invention.

### LIST OF REFERENCE SIGNS

1 Ultrasonic flow meter
10 Measuring tube
2 Ultrasonic fill level measuring device
20 Container
21 Tank
100 Method
101 First method step
102 Second method step
103 Third method step
104 Fourth method step
M1 First media property
M2 Second media property
MF Measured value provided by field device
SM Sensor measured value
BW Calculation value
Z Relationship
U1 First ultrasonic transducer
U2 Second ultrasonic transducer
77 Electronic measuring/operating circuit
S Sensor

1-14. (canceled)

15. A method for detecting a measuring error during a measurement of a media property of a medium located in a container using a field device in measurement and automation technology, including:
in a first method step, at least one measurement of at least one first media property being taken using the field device, an electronic measuring/operating circuit providing at least one measured value of the first media property;
in a second method step, at least one second media property, which differs from the at least one first media property, being measured in each case directly using a sensor provided therefor, the electronic measuring/operating circuit providing at least one sensor measured value based on a measurement signal generated by the sensor;
in a third method step, a known relationship between the at least one first media property and the at least one second media property is used to calculate the at least one second media property from the at least one first media property using the electronic measuring/operating circuit, the electronic measuring/operating circuit in each case providing at least one calculation value; and
in a fourth method step, a statement about the functional capability of the corresponding sensor or of the measuring device being derived by comparing the at least one sensor measured value with the at least one calculation value.

16. The method of claim 15, wherein, in the case of at least two different sensor measured values, at least one calculation value is used in each case for detecting a measuring error of the first media property or of the second media property.

17. The method of claim 15, wherein different sensors are used for measurements of n different second medium properties, the electronic measuring/operating circuit providing a group of sensor measured values, wherein each element of the group is assigned sensor measured values of each media property to be measured, wherein in each case at least one calculation value for at least two different elements is used for detecting a measuring error of a media property, wherein n is a natural number greater than 1.

18. The method of claim 15, wherein the first media property and the second media property are at least one of the following list: speed of sound, temperature, pressure, density, viscosity, electrical conductivity, thermal conductivity, compressibility, adiabatic coefficient, and pH value.

19. The method of claim 15, wherein the field device is a magnetically inductive flow meter and measures the electrical conductivity of the medium, or wherein the field device is a Coriolis measuring device, and measures the density and the viscosity of the medium, or wherein the field device is an ultrasonic flow meter or an ultrasonic fill level measuring device and measures the speed at which sound travels in the medium, or wherein the field device is a thermal flow meter and measures a temperature or thermal conductivity of the medium.

20. The method of claim 19, wherein the ultrasonic flow meter operates according to the propagation time difference principle, and the container is a measuring tube through which the medium flows.

21. The method of claim 15, wherein the medium is gaseous or liquid, wherein the medium includes at least one of the following substances: water, one or more hydrocarbon compounds, and air.

22. The method of claim 15, wherein a notification is output when a calculation value deviates from an associated sensor measured value by more than 20%.

23. The method of claim 22, wherein the sensor belonging to the sensor measured value is recalibrated based on the measured deviation.

24. The method of claim 15, wherein the electronic measuring/operating circuit tracks and records the progression of a deviation between the sensor measured values and the associated calculation values.

25. An ultrasonic flow meter or ultrasonic fill level measuring device, comprising:
at least one first ultrasonic transducer for generating and detecting an ultrasonic signal;
at least one sensor for detecting a media property and/or at least one terminal for connecting a sensor for detecting a media property; and
an electronic measuring/operating circuit for operating a field device and for ascertaining a flow or a fill level by using the first ultrasonic transducer;
wherein the ultrasonic flow meter or ultrasonic fill level measuring device is configured to:
take a first measurement of a first media property using the field device, the electronic measuring/operating circuit providing at least one measured value of the first media property;
take a second measurement of a second media property using the sensor, the electronic measuring/operating circuit providing at least one sensor measured value based on a measurement signal generated by the sensor;
use a relationship between the first media property and the second media property to calculate the second media property from the first media property using the electronic measuring/operating circuit, the electronic measuring/operating circuit providing at least one calculation value; and
derive a statement about the functional capability of the sensor or of the measuring device by comparing the sensor measured value with the calculation value.

26. The ultrasonic flow meter or ultrasonic fill level measuring device of claim 25, wherein the ultrasonic flow meter or ultrasonic fill level measuring device is attached to a container.

27. The ultrasonic flow meter or ultrasonic fill level measuring device of claim 25, wherein the ultrasonic flow meter or ultrasonic fill level measuring device includes a container, the container being a measuring tube designed to conduct the medium.

28. The ultrasonic flow meter or ultrasonic fill level measuring device of claim 27, wherein the ultrasonic flow meter of the ultrasonic fill level measuring device includes at least one second ultrasonic transducer for measuring the speed at which sound travels in the medium.
